(19) United States
(12) Patent Application Publication
(10) Pub. No.: US 2022/0134178 A1
(43) Pub. Date: May 5, 2022

(54) RUNNING BELTS OF TREADMILLS AND METHODS OF FABRICATING THE SAME

(71) Applicant: CHENG HSIUNG RUBBER INDUSTRIAL CO., LTD., Taoyuan City (TW)

(72) Inventors: Hsin-Fan LIN, Taoyuan City (TW); Ti-Chen YAO, Taoyuan City (TW)

(73) Assignee: CHENG HSIUNG RUBBER INDUSTRIAL CO., LTD., Taoyuan City (TW)

(21) Appl. No.: 17/211,386

(22) Filed: Mar. 24, 2021

(30) Foreign Application Priority Data
Nov. 4, 2020 (TW) 109138508

(51) Int. Cl. A63B 22/02; D02G 3/04; D02G 3/12

(52) U.S. Cl. CPC A63B 22/0285; A63B 2209/00; D02G 3/12; D02G 3/04

(57) ABSTRACT

A method for manufacturing a running belt of a treadmill is provided, including: attaching at least one plastic to the outer side of the seamless loop fabric; inserting a plate-shaped mold core into the inner side of the seamless loop fabric; using a mold to hot-press the plastic and the seamless loop fabric to form a loop running belt, which including: a plastic structure and a seamless loop fabric; wherein the plastic structure has a racetrack surface and a joint surface, and the racetrack surface is formed with uneven patterns; the seamless loop fabric has a supporting surface and rolling surface, and he supporting surface is bonded to the joint surface.

### CROSS-REFERENCE TO RELATED APPLICATION

This application claims the priority of Taiwanese patent application No. 109138508, filed on Nov. 4, 2020, which is incorporated herewith by reference.

### BACKGROUND OF THE INVENTION

### 1. Field of the Invention

The present invention relates generally to a running belt and method of fabricating the same, and more particularly, to a running belt of treadmills and method of fabricating the same

### 2. The Prior Arts

Nowadays, people pay more attention to health and many people use treadmills to exercise due to the limitation of venue and time. The main structure of the treadmill includes a rectangular frame, a running board arranged in the rectangular frame, two rollers pivoted on the front and rear sides of the running board, and a running belt surrounding the two rollers and the upper and lower surfaces of the running board. Existing running belts include a fabric layer, such as polyester cloth, as a base material and a plastic layer, such as polyvinyl chloride leather and/or rubber, as a rolling surface. The manufacturing method is a roll-to-roll bonding of fabric and plastic to form a fabric-plastic composite, then according to the size cut into a ribbon-shaped fabric-plastic composite with opposite 45-degree oblique angles at both ends, and the two ends of the ribbon-shaped fabric-plastic composite are joined to form a loop running belt.

Since the joint of the inner fabric layer of the loop running belt forms an oblique seam at an angle of about 45 degrees, the seam is not flat compared to the non-joint part of the running belt. When the user runs at a speed that makes the seam pass through the drum twice every second, the noise of the running belt will affect the neighbors if the treadmill is used in the residential building. Moreover, the durability at the joint is less than the rest of the running belt. After a period of use, the running belt usually cracks or breaks at the joint. Even if the rolling surface is not worn out, the running belt still needs to be replaced, otherwise safety problems may occur. How to solve the problems of joint noise and potential damage of the running belt is the main objective of developing the present invention.

### SUMMARY OF THE INVENTION

To achieve the above objective, the present invention provides a running belt of a treadmill, comprising: a plastic structure and a seamless loop fabric. The plastic structure has a racetrack surface and a joint surface, wherein the racetrack surface is formed with a non-planar pattern. The loop fabric has a supporting surface and a rolling surface, wherein the supporting surface is adhered to the joint surface.

In a preferred embodiment of the present invention, the plastic structure includes a first plastic layer and a second plastic layer superimposed, the racetrack surface is formed on one side of the first plastic layer, and the joint surface is formed on one side of the second plastic layers.

In a preferred embodiment of the present invention, the material of the aforementioned plastic structure is polyvinyl chloride or rubber.

In a preferred embodiment of the present invention, the seamless loop fabric is a seamless knitted fabric or a double-layer plain woven fabric.

In a preferred embodiment of the present invention, the plastic structure includes conductive fillers, and the seamless loop fabric includes conductive fibers.

To achieve the above objective, the present invention also provides a method for manufacturing a running belt of a treadmill, which includes: inserting a plate-shaped core into an inner surface of the seamless loop fabric; attaching at least one plastic to an outer surface of the seamless loop fabric; and hot-pressing the plastic and seamless loop fabric with a mold to form an loop running belt.

In a preferred embodiment of the present invention, the seamless loop fabric is a seamless three-dimensional knitted fabric or a double-layer plain woven fabric.

In a preferred embodiment of the present invention, the seamless loop fabric includes conductive fibers, and the plastic includes conductive fillers.

In a preferred embodiment of the present invention, the plastic includes a first rubber layer and a second rubber layer that are attached to each other, and the second rubber layer is attached to the outer surface of the seamless loop fabric.

In a preferred embodiment of the present invention, the above manufacturing method further includes: demolding the loop running belt from the mold with a release agent.

The present invention uses a seamless loop fabric as the supporting substrate of the running belt and the rolling surface that contacts the treadmill rollers. With the seamless loop fabric, a special plate-shaped core and outer mold are used to make a seamless loop running belt; the inner surface of the running belt manufactured according to the present invention is completely free of seams and uneven surfaces, and the overall tensile strength and abrasion resistance of the running belt are uniform, which greatly increases the service life of the running belt and effectively reduces the noise when the running belt passes through the treadmill rollers.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic cross-sectional view illustrating a running belt of a treadmill according to an embodiment of the present invention; and

FIG. 2 is a flowchart of the manufacturing method of a running belt of a treadmill according to an embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

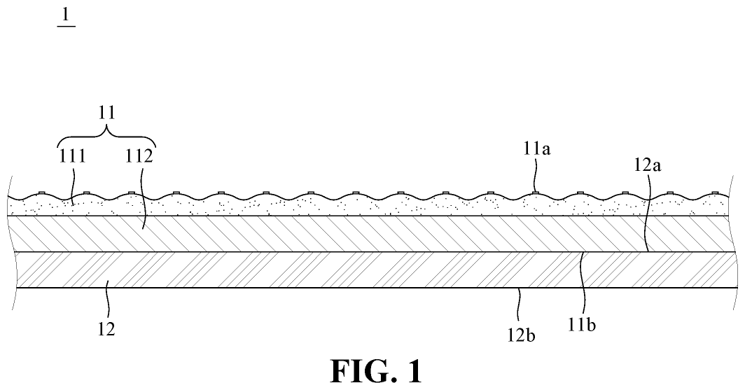

FIG. 1 is a schematic cross-sectional view illustrating a running belt of a treadmill according to an embodiment of the present invention. As shown in FIG. 1, the running belt 1 of the treadmill includes a plastic structure 11 and a seamless loop fabric 12. The plastic structure 11 has a racetrack surface 11a and a joint surface 11b. The racetrack surface 11a is formed with a concave-convex pattern, for example, checkered pattern, diamond pattern, wave pattern, snow pattern, etc., to increase friction during running. The seamless loop fabric 12 has a supporting surface 12a and a rolling surface 12b, wherein the supporting surface 12a is adhered to the joint surface 11b, the supporting surface 12a can support the shape of the plastic structure 11, and the rolling surface 12b can cyclically rotate on the rollers of the treadmill endlessly.

The plastic structure 11 includes one or more plastic layers, and the materials of the plurality of plastic layers may be the same or different, for example: polyvinyl chloride (PVC), polyurethane (PU), natural rubber (NR), polyethylene (PE), Styrene butadiene rubber (SBR), thermoplastic rubber (TPR), thermoplastic polyurethane (TPU), styrene-based thermoplastic elastomer (SBS), nitrile rubber (NBR) and ethylene propylene rubber (EPDM). The seamless loop fabric 12 is a seamless three-dimensional knitted fabric or a double-layer plain woven fabric with a closed edge, or other material, such as high-strength polyester fiber, nylon fiber, and polypropylene fiber.

In the present embodiment, the plastic structure 11 includes a first plastic layer 111 and a second plastic layer 112 that are superimposed together. The racetrack surface 11a is formed on one surface of the first plastic layer 111, and the joint surface 11b is formed on one surface of the second plastic layer 112. The material of the first plastic layer 111 is rubber with abrasion resistance, such as natural rubber NR mixed with styrene butadiene rubber SBR, and the material of the second plastic layer 112 is rubber with a cushioning function, such as natural rubber NR. Since running on the running belt is prone to friction, static electricity and heat, the plastic structure 11 may be added with conductive fillers with high thermal conductivity such as graphite, carbon black, graphene, and so on. The seamless loop fabric can be woven with metal threads, carbon fibers, and conductive graphite. Such conductive material fibers make the fabric conductive; thereby, the conductive fillers and conductive fibers contained in the running belt can quickly conduct frictional static electricity to the grounding wire of the treadmill, and can evenly disperse the frictional heat of the racetrack surface 11 a.

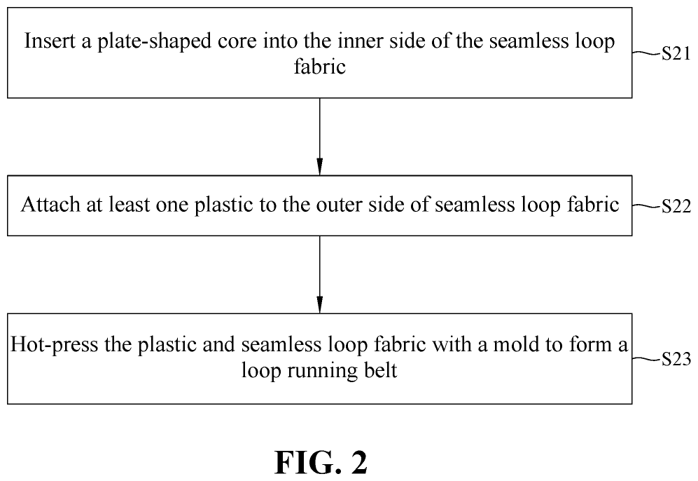

FIG. 2 is a flow chart of the manufacturing method of running belt of the treadmill of the present invention. As shown in FIG. 2, the manufacturing method of the running belt of the treadmill includes: step S21, inserting a plate-shaped core into the inner side of the seamless loop fabric; step S22, attaching at least one plastic to the outer side of seamless loop fabric; Step S23, hot-pressing the plastic and seamless loop fabric with a mold to form a loop running belt. The width of the loop running belt installed on the running board is between 45 and 50 cm, the length is between 130 and 150 cm, and the thickness of the track surface is between 1.5 and 4 mm.

Using synthetic rubber as an example, the manufacturing method of a running belt includes: coating a sulfur-containing bridging agent on the surface of the wear-resistant rubber layer, and pre-laminating a buffer rubber to the surface of the wear-resistant rubber layer to form an unshaped composite rubber layer; using a vulcanized adhesive that can bond rubber and fabric, such as THIXON vulcanized adhesive from DuPont, USA, and applying the adhesive on the outer surface of the seamless loop conductive polyester fabric with a scraper or roller; inserting a metal plate-shaped mold core into the inner side of the seamless loop conductive polyester fabric to make the seamless loop conductive polyester fabric flatly adhered to the surface of the metal plate-shaped mold core, wherein the metal plate-shaped mold core corresponds to the shape (flat or bow) and size of the running board; surrounding and attaching the unshaped composite rubber layer to the outer side of the seamless loop conductive polyester fabric; arranging the composite rubber layer and the seamless loop conductive polyester fabric into a metal outer mold, wherein the inner side of the metal outer mold is formed with concave and convex patterns, closing the outer mold, adding vulcanizing agent and pressurizing to 300 tons/square meter (i.e., clamping force), heating up to 160 degrees Celsius, and baking for at least 30 minutes to shape the composite rubber layer and be bonded to the outer side of the seamless loop conductive polyester fabric; opening the outer mold to take out the plate-shaped mold core, and demolding the composite rubber layer from the outer mold with a fluorine release agent to obtain a seamless loop running belt.

Using polyvinyl chloride as an example, the manufacturing method of the running belt includes: preparing a polyvinyl chloride colloid containing conductive fillers; using an impregnating machine to adsorb the seamless loop conductive polyester fabric to the polyvinyl chloride colloid; inserting a metal plate-shaped mold core into the inner side of the seamless loop conductive polyester fabric that absorbs polyvinyl chloride colloid; arranging the seamless loop conductive polyester that absorbs polyvinyl chloride colloid into a metal outer mold, wherein the inner side of the outer mold is formed with a concave-convex pattern, closing the outer mold, pressurizing and heating to make the polyvinyl chloride molded and bonded to the seamless loop conductive polyester fabric; opening the outer mold to take out the plate-shaped core, and demolding to obtain a seamless loop running belt. To increase the cushioning and mechanical strength of the running belt, two seamless loop conductive polyester fabrics that absorb polyvinyl chloride colloid may be stacked onto the plate-shaped mold core, and then baked and shaped to make a double-layer plastic/fabric seamless loop running belt.

As aforementioned, the present invention uses the seamless loop fabric as the supporting substrate of the plastic structure of the running belt and the rolling surface contacting the treadmill rollers, and the seamless loop fabric uses a special plate-shaped core and an outer mold to manufacture a seamless loop running belt. The rolling surface of the inner side of the running belt manufactured according to the present invention is completely free of uneven seam. The overall tensile strength and wear resistance of the running belt are uniform, which greatly increases the service time of the running belt and effectively reduces the wear and noise of the running belt passing through the rollers, achieving the objective of the invention.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A running belt of a treadmill, comprising:
a plastic structure, having a racetrack surface and a joint surface, wherein the racetrack surface is formed with a non-planar pattern; and
a seamless loop fabric, having a supporting surface and a rolling surface, wherein the supporting surface is adhered to the joint surface.

2. The running belt of a treadmill according to claim 1, wherein the plastic structure comprises a first plastic layer and a second plastic layer superimposed, the racetrack surface is formed on one side of the first plastic layer, and the joint surface is formed on one side of the second plastic layers.

3. The running belt of a treadmill according to claim 1, wherein the material of the plastic structure is polyvinyl chloride or rubber.

4. The running belt of a treadmill according to claim 1, wherein the seamless loop fabric is a seamless knitted fabric or a double-layer plain woven fabric.

5. The running belt of a treadmill according to claim 1, wherein the plastic structure comprises conductive fillers, and the seamless loop fabric comprises conductive fibers.

6. A method for manufacturing a running belt of a treadmill, comprising the following steps of:
inserting a plate-shaped core into an inner surface of a seamless loop fabric;
attaching at least one plastic to an outer surface of the seamless loop fabric; and
hot-pressing the plastic and seamless loop fabric with a mold to form a loop running belt.

7. The method for manufacturing a running belt of a treadmill according to claim 6, wherein the seamless loop fabric is a seamless three-dimensional knitted fabric or a double-layer plain woven fabric.

8. The method for manufacturing a running belt of a treadmill according to claim 6, wherein the seamless loop fabric includes conductive fibers, and the plastic includes conductive fillers.

9. The method for manufacturing a running belt of a treadmill according to claim 6, wherein the plastic includes a first rubber layer and a second rubber layer that are attached to each other, and the second rubber layer is attached to the outer surface of the seamless loop fabric.

10. The method for manufacturing a running belt of a treadmill according to claim 6, further comprising a step of: demolding the loop running belt from the mold with a release agent.
